(19) United States
(12) Patent Application Publication
(10) Pub. No.: US 2006/0269228 A1
(43) Pub. Date: Nov. 30, 2006

(54) INFORMATION PLAYING APPARATUS, INFORMATION PLAYING METHOD, AND INFORMATION RECORDING MEDIUM

(76) Inventors: Kazuyoshi Shimomura, Fuchu-shi (JP); Hitoshi Yoshida, Kawasaki-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/419,076

(22) Filed: May 18, 2006

(30) Foreign Application Priority Data
May 31, 2005 (JP) 2005-160347

(51) Int. Cl. H04N 7/00

(52) U.S. Cl. 386/95

(57) ABSTRACT

According to one embodiment, in the case where information for displaying a menu screen for playing a title is included in management information contained in an information recording medium mounted on a mount unit, information corresponding to a preset title is directly played from an information recording medium without playing the information for displaying the menu screen.

### CROSS-REFERENCE TO RELATED APPLICATIONS

This application is based upon and claims the benefit of priority from Japanese Patent Application No. 2005-160347, filed May 31, 2005, the entire contents of which are incorporated herein by reference.

### BACKGROUND

1. Field

One embodiment of the present invention relates to improvements of an information playing apparatus and an information playing method for playing an information recording medium such as, for example, an optical disk. The present invention also relates to an information recording medium having recorded therein information for controlling a play function at the time of playing by the information playing apparatus.

2. Description of the Related Art

As is well known, currently, an optical disk called a Digital Versatile Disk (DVD) is prevalently used as an information recording medium. The current DVD standards include, for example, a read only DVD-ROM (read only memory) standard, a write-once DVD-R (recordable) standard, a rewritable type (about 1000-times rewritable) type DVD-RW (rewritable) standard, and a rewritable (10,000-times rewritable) type DVD-RAM (random access memory) standard.

These standards include: format standards for defining a data structure recorded on an optical disk (information recording medium) of picture information itself (video objects called video data, sub-picture data, and audio data), and a data structure of management data for managing the picture information.

Among them, a play only current DVD video standard includes a format that can provide user oriented picture content. This DVD video standard is compatible with multiple languages at the same time and enables multi-scene expression such as multi-angle/multi-story expression. In addition, this DVD video standard includes a variety of menu screens and easily provides direct access to a scene which a user wants to see.

In the meantime, examples of such optical disks that conform to the DVD video standard include, as in an optical disk or the like having a music clip recorded therein, an optical disk featured in that, when starting play of a first feature, the title is not played unless a menu screen is first displayed, and the user makes a predetermined operation such as selecting a title to be played, for example.

On the other hand, as an optical disk playing apparatus for playing an optical disk, a system is constructed so as to supply the above-described picture information obtained by playing the optical disk to an externally connected display or speaker, and then, carry out picture display or audio play. In this case, the user can hear only audio content of the optical disk as long as the display is not started up.

However, as described above, in an optical disk for displaying a menu screen at the time of playing, the optical disk requiring a predetermined operation, there occurs a need for temporarily displaying the menu screen on a display and making the predetermined operation even when an attempt is made to hear only audio content, thus causing the user to handle the optical disk with inconvenience. In particular, this inconvenience becomes a serial problem with a sight-unpaired person.

Jpn. Pat. Appln. KOKAI Publication No. 2003-87748 discloses an optical playing apparatus featured in that, when an optical disk is loaded and played, picture and voice information can be played from a first chapter included in a first title recorded in the optical disk without displaying an opening screen or a menu screen.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram adopted to explain an optical playing apparatus according to an embodiment of the present invention;

FIG. 2 is an external view adopted to explain a remote controller of the optical disk playing apparatus in the present embodiment;

FIG. 3 is a flowchart adopted to explain a first example of a processing operation for the optical disk playing apparatus in the present embodiment to play an optical disk;

FIG. 4 is a view adopted to explain a direct play mode that the optical disk playing apparatus in the present embodiment has as a setup menu;

FIG. 5 is a flowchart adopted to explain an example of a processing operation for the optical disk playing apparatus in the present embodiment to set a direct play mode;

FIG. 6 is a view adopted to explain an example of a menu screen displayed at the time of the processing operation for the optical disk playing apparatus in the present embodiment to set a direct play mode;

FIG. 7 is a view adopted to explain another example of the menu screen displayed at the time of the processing operation for the optical disk playing apparatus in the present embodiment to set a direct play mode;

FIG. 8 is a flowchart adopted to explain a second example of the processing operation for the optical disk playing apparatus in the present embodiment to play an optical disk;

FIG. 9 is a flowchart adopted to explain a direct play flag recorded in the optical disk played by the optical disk playing apparatus in the present embodiment;

FIG. 10 is a flowchart adopted to explain a third example of the processing operation for the optical disk playing apparatus in the present embodiment to play an optical disk;

FIG. 11 is a flowchart adopted to explain a fourth example of the processing operation for the optical disk playing apparatus in the present embodiment to play an optical disk;

FIG. 12 is a flowchart adopted to explain a fifth example of the processing operation for the optical disk playing apparatus in the present embodiment to play an optical disk; and

FIG. 13 is a view adopted to explain an example of a screen for a user to set a title to be played at the time of direct play by the optical disk playing apparatus in the present embodiment.

### DETAILED DESCRIPTION

Various embodiments according to the invention will be described hereinafter with reference to the accompanying drawings. In general, according to one embodiment of the invention, in the case where information for displaying a menu screen for playing a title is included in management information contained in an information recording medium mounted on a mount unit, information corresponding to a preset title is directly played from an information recording medium without playing the information for displaying the menu screen.

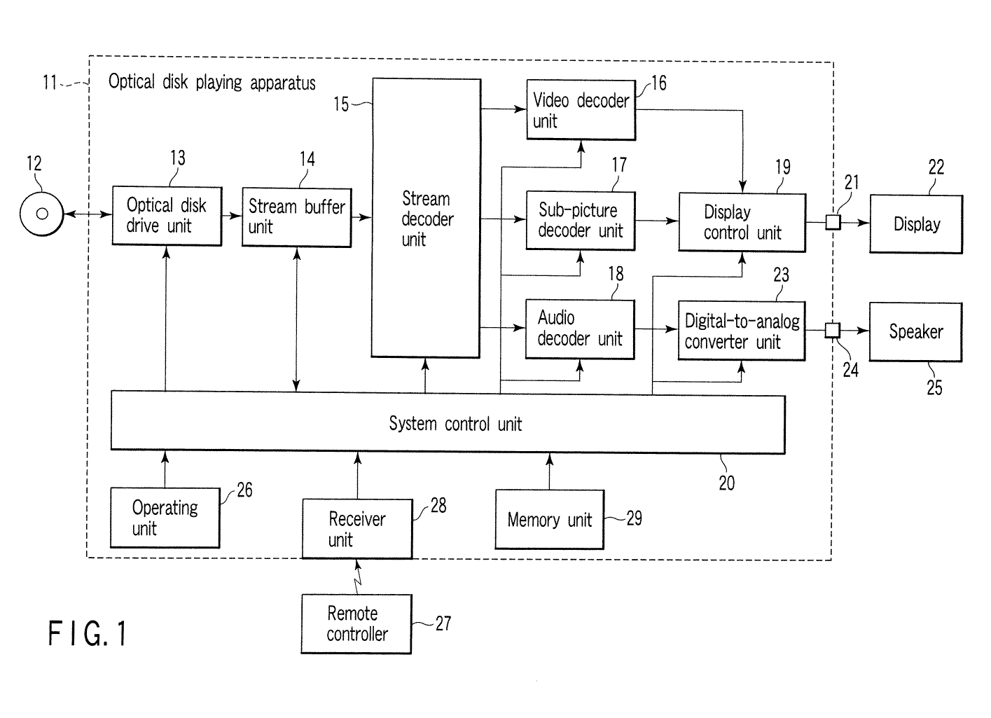

FIG. 1 shows an optical playing apparatus 1 to be explained in the present embodiment. In FIG. 1, reference numberl 12 designates an optical disk serving as an information recording medium, such as a DVD, for example.

This optical disk 12 has recorded therein at least title compatible information (including video data and audio data to be played in synchronism with the video data); and management information for managing the information (including information for displaying a menu screen for playing a title).

In addition, the above optical disk playing apparatus 11 is provided with an optical disk drive unit 13 for removably mounting the optical disk 12. The optical disk drive unit 13 reads the recorded data from the mounted optical disk 12, and outputs the read data after the data has been subjected to a predetermined signal demodulation process and an error correction process, etc.

The data output from the optical disk drive unit 13 is supplied to a stream decoder unit 15 after buffered by a stream buffer unit 14. The stream decoder unit 15 identifies the input stream data by three types of a video pack composed of video data, a sub-picture pack composed of sub-picture data, and an audio pack composed of audio data.

Thereafter, the stream decoder unit 15 transfers the identified three types of data to a video decoder unit 16, a sub-picture decoder unit 17, and an audio decoder unit 18 by referring to ID data indicating a transfer time and a data type recorded in each item of data.

Among them, the video decoder unit 16 applies a decoding process to the video data supplied from the stream decoder unit 15, and outputs the decoded data to a display control unit 19. In addition, the sub-picture decoder unit 17 applies a decoding process to the sub-picture data supplied from the stream decoder unit 15, and outputs the decoded data to the display control unit 19.

The display control unit 19 converts into analog signals, items of digital data supplied from the video decoder unit 16 and sub-picture decoder unit 17, and multiplexes the converted analog signals. Further, the display control unit 19 is configured to also multiplex an on-screen display (OSD) signal set by a system control unit 20 described later. A picture signal output from the display control unit 19 is supplied to an external display 12 via an output terminal 21, and the supplied video image signal is provided for picture display.

In addition, the above audio decoder unit 18 applies a decoding process to the audio data supplied from the stream decoder unit 15, and outputs the decoded data to a digital-to-analog converter unit 23. The digital-to-analog converter unit 23 converts the inputted audio data into an analog signal. Then, an audio signal output from the digital-to-analog converter unit 23 is supplied to an external speaker 25 via an output terminal 24, and the supplied audio signal is provided for audio play.

Here, the optical disk playing apparatus 11 integrally controls all operations including the above-described play operation by means of the above system control unit 20. The system control unit 20 incorporates a central processing unit (CPU) and the like, and controls each unit such that its operational content is reflected by receiving operation information from an operating unit 26 or operation information transmitted from a remote controller 27 via a receiver unit 28.

In this case, the system control unit 20 utilizes a memory unit 29. The memory unit 29 primarily comprises: a ROM having stored therein a control program executed by the CPU; a RAM for providing a work area to the CPU; and a nonvolatile memory in which a variety of setting information and control information, etc. are stored.

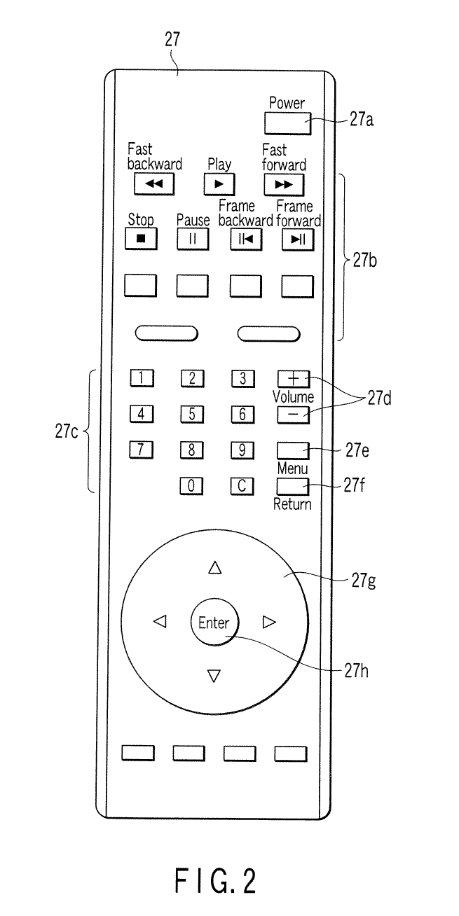

FIG. 2 shows an external view of the above remote controller 27. The remote controller primarily provides: a power supply key 27a; keys 27b relating to play control (fast backward, play, fast forward, stop, pausing, frame backward, and frame forward, etc.); numeric keys 27c, a volume control key 27d, a menu key 27e, a return key 27f, a cursor key 27g, an enter key 27d, and the like.

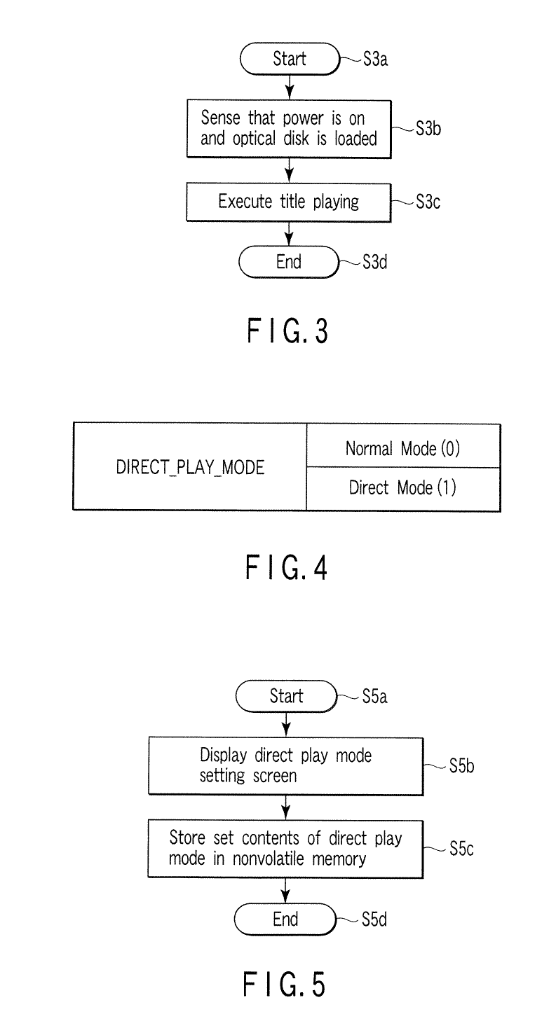

FIG. 3 shows a flowchart for explaining a first example of a processing operation for the optical disk playing apparatus 11 to play the optical disk 12. That is, when processing is started (block S3a), and the system control unit 20 senses that the optical disk playing apparatus 11 is powered on and that the optical disk 12 is loaded in the optical disk drive unit 13 in block S3b, the system control unit 20 directly plays a preset title from the optical disk 12 without displaying a menu screen in block S3c. Namely, the system control unit 20 executes direct play and terminates processing (block S3d).

According to this play operation shown in the first example, direct play of a predetermined time is unconditionally executed without playing a menu screen with respect to the optical disk 12 mounted on the optical disk drive unit 13.

In this manner, a user's operation can be made easy, and the user handling can be made convenient. In addition, it becomes possible to reduce a time required for starting title playing. Moreover, title playing is carried out without using a menu screen, and accordingly, the handling by a sight-unpaired person can be made convenient.

In particular, in a case where a manufacturer sells an optical disk playing apparatus without a video output terminal as an audio player, menu playing itself becomes meaningless, and thus, it is effective to provide setting so as to forcibly carry out direct play.

Now, a description will be given with respect to a second example of the processing operation for the optical disk playing apparatus 11 to play the optical disk 12. In this second example, a direct play mode (DIIRECT_PLAY_MODE) as shown in FIG. 4 is set in a setup menu of the optical disk playing apparatus 11.

This direct play mode enters a Normal Mode for disabling direct play when a user sets “0”, and enters a Direct Mode for enabling direct play when the user sets “1”. That is, the user can selectively set whether or not to carry out direct play.

FIG. 5 shows a flowchart for explaining an example of a processing operation for a user to selectively set a direct play mode. This processing is started (block S5a) in such a manner that the user makes an operation for requesting selective setting of a direct play mode. Then, the system control unit 20 causes a display 22 to display a direct play mode setting screen in block S5b.

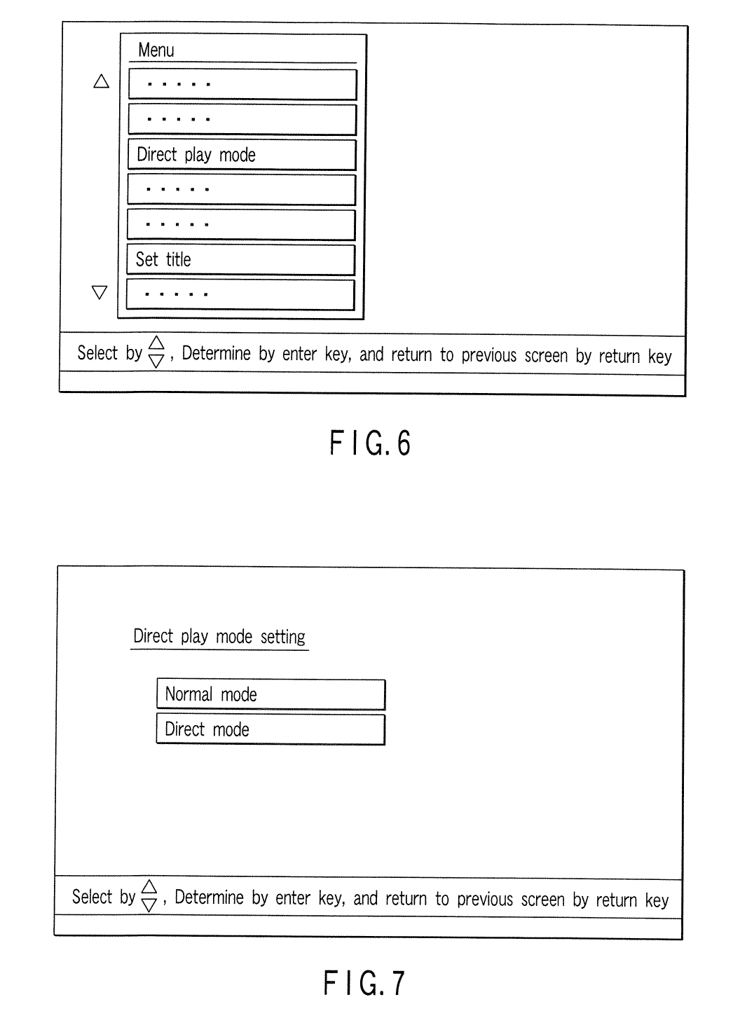

More specifically, when the user operates the menu key 27e of the remote controller 27, the system control unit 20 causes the display 22 to display a menu screen having a variety of selections arranged thereon, as shown in FIG. 6.

Then, when the user selects an item “direct play mode” by the cursor key 27g from among the variety of items displayed on the menu screen, and operates the enter key 27h, the system control unit 20 causes the display 22 to display a direct play mode setting screen, as shown in FIG. 7.

This direct play mode setting screen displays two items “Normal Mode” and “Direct Mode”. The user operates the cursor key 27g, selects any item, and operates the determination key 27h, whereby setting is provided. Thereafter, the system control unit 20 stores the contents of setting the direct play mode in the nonvolatile memory of the above memory unit 29 in block S5c, and terminates processing (block S5d).

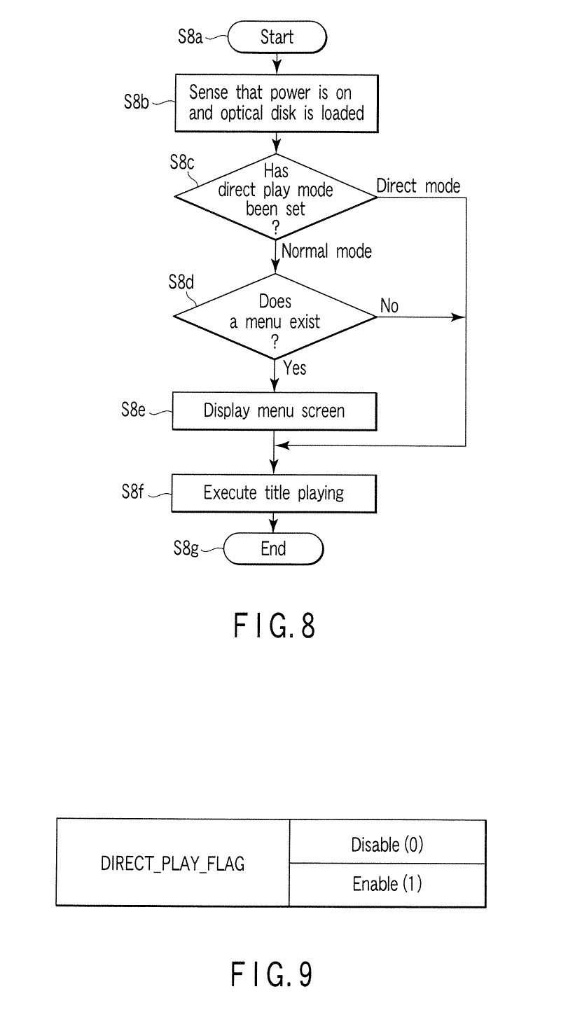

FIG. 8 shows a flowchart for illustrating a processing operation for the optical disk playing apparatus 11 to play the optical disk 12 in response to the set contents of the direct play mode. That is, when processing is started (block S8a), and the system control unit 20 senses that the optical disk playing apparatus 11 is powered on and that the optical disk 12 is loaded in the optical disk drive unit 13 in block S8b, the system control unit 20 reads out the set content of the direct play mode recorded in the nonvolatile memory of the memory unit 29, and discriminates whether the normal mode or direct mode is set in block S8c.

When it is determined that the normal mode is set, the above system control unit 20 reads out management information (such as video manager information [VMGI] or video title set information [VYMI]) recorded in the optical disk 12, and discriminates whether a video manager menu_object (VMGM_VOB) or a video title set menu_video object (VTSM_VOB) exists in block S8d.

When it is determined that the above menu exists (YES), the system control unit 20 plays that menu and causes the display 22 to display a menu display in block S8e. The system control unit 20 then plays the title selected on the above menu screen in block S8f and terminates processing (block S8g).

When it is determined that the direct mode is set in the above block S8c or when no menu exists in the above block S8d (NO), the system control unit 20 plays a preset title from the optical disk 12 in block S8f without displaying the menu screen, and terminates processing (block S8g).

According to the play operation shown in this second example, the direct play mode is set in the setup menu of the optical disk playing apparatus 11, so that the user can selectively set whether or not to carry out direction play with respect to the loaded optical disk 12. Consequently, the user's convenience can be improved more remarkably.

Now, a description will be given with respect to a third example of a processing operation for the above optical disk playing apparatus 11 to play the optical disk 12. In this third example, a direct play flag (DIRECT_PLAY_FLAG) indicating whether to enable or disable direct play as shown in FIG. 9 is set in a recording region in which the above management information contained in the optical disk 12 is recorded.

The direct play flag enters a mode for disabling direct play when a user sets “0” or enters a mode for enabling direct play when the user sets “1”. That is, a provider of the optical disk 12 can control whether or not the user may carry out direct play.

This direct play flag is included in video manager information (VMGI) in the case of the optical disk 12 that conform to a DVD video standard. The direct play flag is automatically read when the optical disk 12 is loaded in the optical disk drive unit 13 and when the optical disk playing apparatus 11 is powered on.

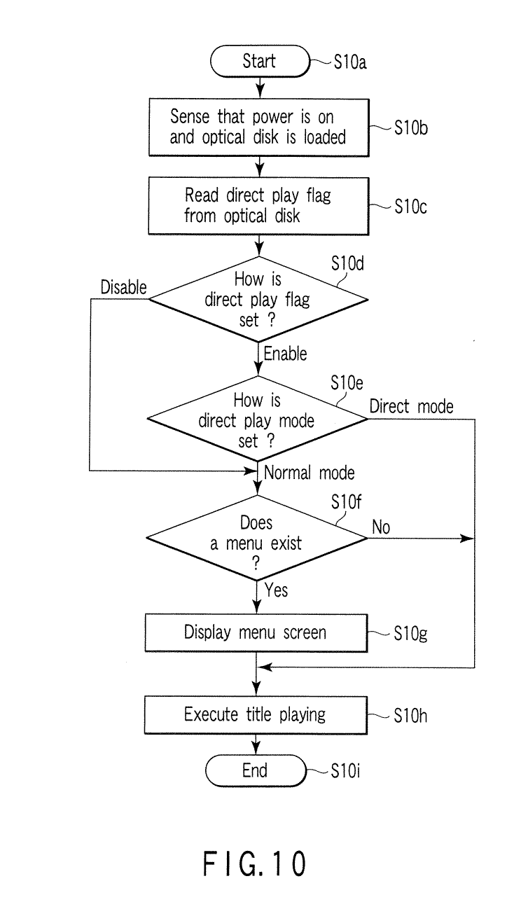

FIG. 10 shows a flowchart for explaining a processing operation for the optical disk playing apparatus 11 to play the optical disk 12 in response to the set contents of the direct play flag and direct play mode.

That is, when processing is started (block S10a), and the system control unit 20 senses that the optical disk playing apparatus 11 is powered on and that the optical disk 12 is loaded in the optical disk drive unit 13 in block S10b, the system control unit 20 reads the direct play flag recorded on the optical disk 12 in block S10c, and discriminates whether to disable or enable direct play in block S10d.

When it is determined that direct play is enabled, the system control unit 20 reads the set contents of the direct play mode recorded in the nonvolatile memory of the memory unit 29 in block S10e, and discriminates whether the normal mode or direct mode is set.

When it is determined that the normal mode is set or When it is determined that direct play is disabled in the above block S10d, the system control unit 20 reads management information (such as video manager information [VMGI] or video title set information [VTSI]) recorded on the optical disk 12, and discriminates whether or not a menu (video manager menu_video object [VTGM_VOB] or video title set menu_video object [VTSM_VOB]) exists in the read management information in block S10f.

When it is determined that the above menu exists (YES), the system control unit 20 plays that menu and causes the display 22 to display a menu screen in block S10g. Then, the system control unit 20 plays the title selected on the menu screen in block S10h, and terminates processing (in block S10i).

When it is determined that the direct mode is set in the above block S10e or when it is determined that no menu exists in the above block S10f (NO), the system control unit 20 plays a preset title from the optical disk 12 in block S10h without displaying the menu screen, and terminates processing (block S10i).

According to the play operation shown in this third example, a direct play flag indicating whether to enable or disable direct play is set in a recording region in which management information contained in the optical disk 12 is recorded, so that a provider of the optical disk 12 can control whether or not the user may carry out direct play. Thus, it becomes possible to promote practical operation.

Next, a description will be given with respect to a fourth example of the processing operation for the above optical disk playing apparatus 11 to play the optical disk 12. In this fourth example, a direct play program chain (DIRECT_PLAY_PGC) indicating a title to be played at the time of direct play is set in a recording region in which the above management information contained in the optical disk 12 is recorded. The direct play program chain is assumed to have the same structure as that of a first play PGC (FP_PGC) that exists in the current DVD video standard.

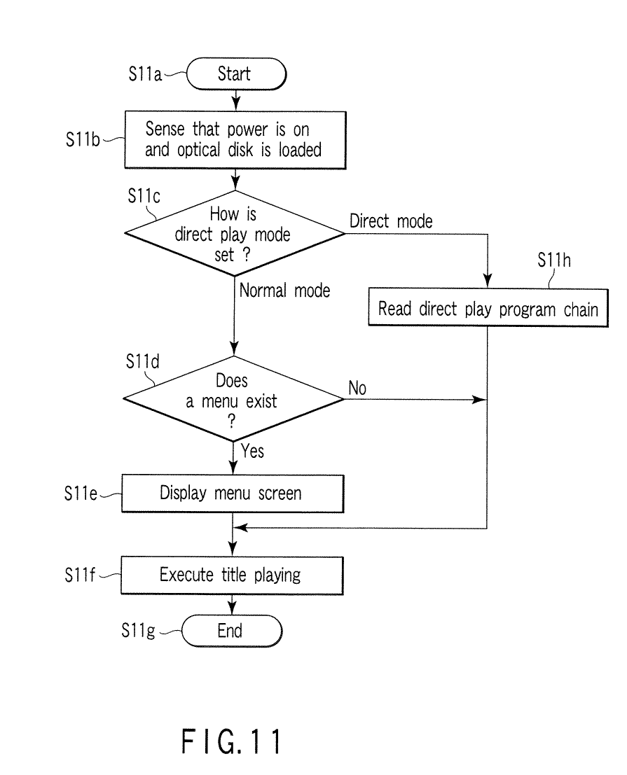

FIG. 11 shows a flowchart for explaining a processing operation for the optical disk playing apparatus 11 to play the optical disk 12 in response to the set contents of the direct play mode and direct play program chain.

That is, when processing is started (block S10a), and the system control unit 20 senses that the optical disk playing apparatus 11 is powered on and that the optical disk 12 is loaded in the optical disk drive unit 13 in block S11b, the system control unit 20 reads out the set content of the direct play mode recorded in the nonvolatile memory of the memory unit 29, and discriminates whether the normal mode or direct mode is set, in block S11c.

When it is determined that the normal mode is set, the above system control unit 20 reads management information (such as video manager information [VMGI] or video title set information [VTSI]) recorded on the optical disk 12, and discriminates whether or not a menu (video manager menu object [VMGFM_VOB] or video title set menu_video object [VTSM_VOB]) exists in the read management information, in block S11d.

When it is determined that the above menu exists (YES), the system control unit 20 plays that menu and causes the display 22 to display a menu screen in block S11e. Then, the system control unit 20 plays the title selected on the menu screen in block S11f, and terminates processing (block S11g).

When it is determined that the direct mode is set in the above block S11c, the system control unit 20 reads the direct play program chain from the optical disk 12 in block S11h, plays a title shown in the direct play program chain in block S11f, and terminates processing (block S11g).

Further, When it is determined that no menu exists in the above block S11d (NO), the system control unit 20 plays a preset the from the optical disk 12 in block f11 without displaying the menu screen, and terminates processing (block S11g).

According to the play operation shown in this fourth embodiment, the direct play program chain indicating a title to be played has been set when direct play is carried out with respect to the loaded optical disk 12, so that user's convenience can be improved more remarkably.

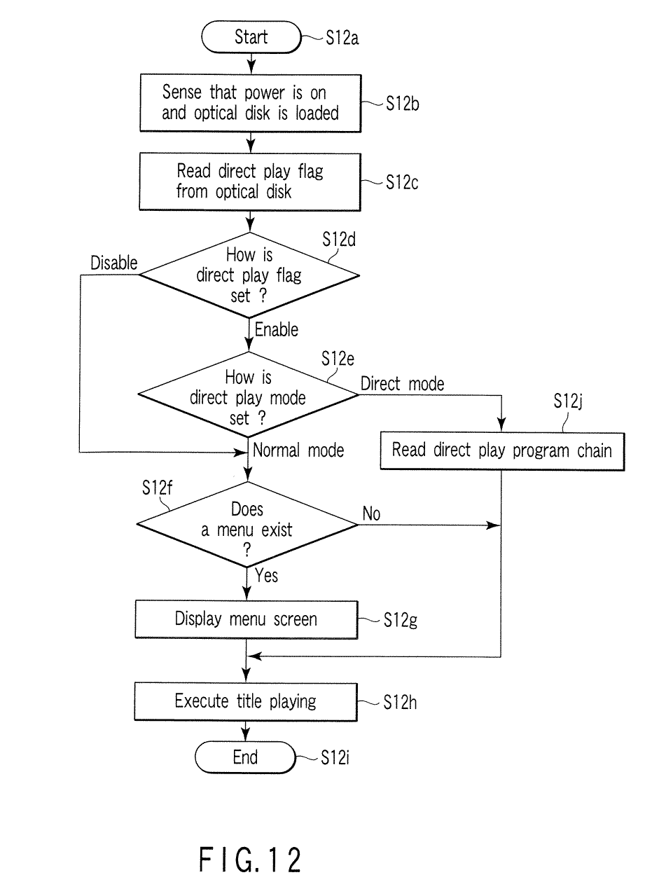

Now, a description will be given with respect to a fifth example of the processing operation for the above optical disk playing apparatus 11 to play the optical disk 12. FIG. 12 shows a flowchart for explaining a processing operation for the optical disk playing apparatus 11 to play the optical disk 12 in response to the set content of the direct play flag, direct play mode, and direct play program chain.

That is, when processing is started (block S12a), and the system control unit 20 senses that the optical disk playing apparatus 11 is powered on and that the optical disk 12 is loaded in the optical disk drive unit 13 in block S12b, the system control unit 20 reads the direct play flag recorded on the optical disk 12 in block S12c, and discriminates whether to disable or enable direct play in block S12d.

When it is determined that direct play is enabled, the system control unit 20 reads the set contents of the direct play mode recorded in the nonvolatile memory of the memory unit 29, and discriminates whether the normal mode or direct mode is set, in block S12e.

When it is determined that the normal mode is set or when it is determined that direct play is disabled in the above block S12d, the system control unit 20 reads management information (such as video manager information [VMGI] or video title set information [VTSI]) recorded in the optical disk 12, and discriminates whether or not a menu (video manager menu_video object [VMGI_VIB] or video title set menu_video object [VTSM_VOB]) exists in the read management information, in block S12f.

When it is determined that the above menu exists (YES), the system control unit 20 plays that menu and causes the display 22 to display a menu screen in block S12g. Then, the system control unit 20 plays the title selected on the above menu screen in block S12h, and terminals processing (block S12i).

When it is determined that the direct mode is set in the above block S12e, the system control unit 20 reads the direct play program chain from the optical disk 12 in block S12j, plays the title indicated in the direct play program chain in block S12h, and terminates processing (block S12i).

Further, when it is determined that no menu exists in the above block S12f (NO), the system control unit 20 plays a preset title from the optical disk 12 in block S12h without displaying the menu screen, and terminates processing (block S12i).

According to the play operation shown in this fifth example, playing is carried out with respect to the loaded optical disk 12 based on the set content of the direct play flag, the direct play mode, and the direct play program chain. Consequently, the user's convenience can be improved more remarkably, making it possible to promote practical operation.

In the above fourth and fifth examples, while the title to be played at the time of direct play is preset by means of the direct play program chain, it is possible for the user to enable setting of the title played at the time of direct play.

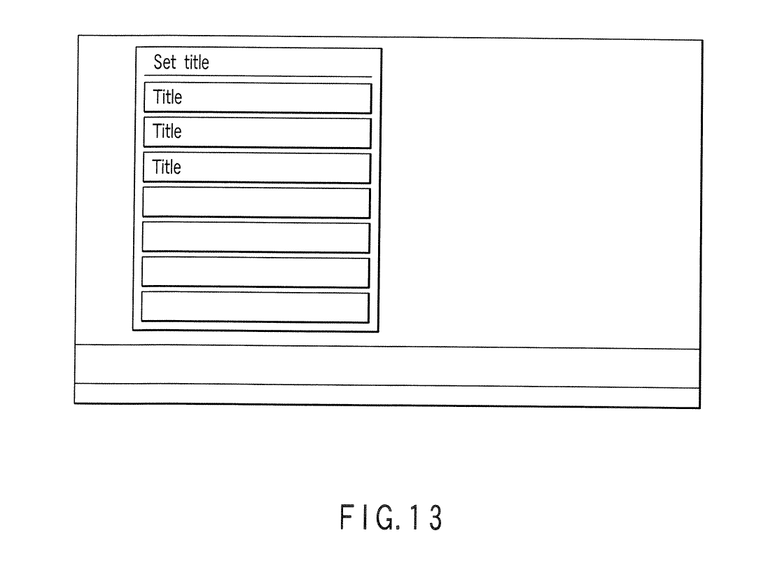

That is, the user operates the menu key 27e of the remote controller 27, thereby causing the display 22 to display a menu screen, as shown in FIG. 6. When the user selects an item “set title” by the cursor key 27g from among a variety of items displayed on the menu screen, and operates the enter key 27h, a title setting screen is displayed on the display 22 as shown in FIG. 13. Then, the titles to be played are sequentially set in order of playing on the title setting screen, thereby making it possible to carry out direct play of titles set by the user.

In addition, while the foregoing embodiment has described an example of the optical disk 12 serving as the information recording medium, the present invention is not limited thereto. Of course, the present invention can be applied to an apparatus for playing a variety of information recording media such as a semiconductor memory, a tape, and a hard disk.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information playing apparatus configured to play an information recording medium having recorded therein information corresponding to a title and management information thereon, the apparatus comprising:
a mount unit configured to mount the information recording medium thereon; and
a play control unit configured to, in the case where information for displaying a menu screen for playing the title is included in the management information contained in the information recording medium mounted on the mount unit, directly play information corresponding to a preset title from the information recording medium without playing the information for displaying the menu screen.

2. An information playing apparatus according to claim 1, wherein the play control unit comprises:
a setting unit configured to, in the case where information for displaying a menu screen for playing the title is included in a management region of the information recording medium mounted on the mount unit, set whether to carry out direct play of information corresponding to a preset title from the information recording medium without playing the information for displaying the menu screen; and
a control unit configured to, when information for enabling the direct play is included in the management region of the information recording medium mounted on the mount unit and the direct play is set to be carried out by the setting unit, carry out direct play with respect to the information recording medium mounted on the mount unit.

3. An information playing apparatus according to claim 1, wherein the play control unit comprises:
a setting unit configured to, in the case where information for displaying a menu screen for playing the title is included in a management region of the information recording medium mounted on the mount unit, set whether to carry out direct play of information corresponding to a preset title from the information recording medium without playing the information for displaying the menu screen; and
a control unit configured to, when the direct play is set to be carried out by the setting unit, carry out direct play with respect to the information recording medium mounted on the mount unit on the basis of information indicating a title for carrying out direct play contained in the management information of the information recording medium mounted on the mount unit.

4. An information playing apparatus according to claim 1, wherein the play control unit comprises:
a setting unit configured to, in the case where information for displaying a menu screen for playing the title is included in a management region of the information recording medium mounted on the mount unit, set whether to carry out direct play of information corresponding to a preset title from the information recording medium without playing information for displaying the menu screen; and
a control unit configured to, when information for enabling the direct play is included in the management region of the information recording medium mounted on the mount unit and the direct play is set to be carried out by the setting unit, carry out direct play with respect to the information recording medium mounted on the mount unit on the basis of information indicating a title for carrying out direct play included in the management information contained in the information recording medium mounted on the mount unit.

5. An information playing method for playing an information recording medium having recorded therein information corresponding to a title and management information thereon, the method comprising:
a mounting block of mounting the information recording medium;
a play control block of, in the case where information for displaying a menu screen for playing the title is included in the management information contained in the information recording medium mounted on the mount unit, directly playing information corresponding to a preset title from the information recording medium without playing the information for displaying the menu screen.

6. An information playing method according to claim 5, wherein the play control block comprises:
a setting block of, in the case where the information for displaying a menu screen for playing the title is included in a management region of the information recording medium mounted in the mounting block, setting whether to carry out direct play of information corresponding to a preset title from the information recording medium without playing the information for displaying the menu screen; and
a control block of, when information for enabling the direct play is included in the management region of the information recording medium mounted in the mounting block and the direct play is set to be carried out in the setting block, carrying out direct play with respect to the information recording medium mounted in the mounting block.

7. An information playing method according to claim 5, wherein the play control block comprises:
a setting block of, in the case where information for displaying a menu screen for playing the title is included in a management region of the information recording medium mounted in the mounting block, setting whether to carry out direct play of information corresponding to a preset title from the information recording medium without playing the information for displaying the menu screen; and
a control block of, when the direct play is set to be carried out in the setting block, carrying out direct play with respect to the information recording medium mounted in the mounting block on the basis of information indicating a title for carrying out direct play contained in the management information of the information recording medium mounted in the mounting block.

8. An information playing method according to claim 5, wherein the play control block comprises:
a setting block of, in the case where information for displaying a menu screen for playing the title is included in a management region of the information recording medium mounted in the mounting block, setting whether to carry out direct play of information corresponding to a preset title from the information recording medium without playing the information for displaying the menu screen; and
a control block of, when information for enabling the direct play is included in the management region of the information recording medium mounted in the mounting block and the direct play is set to be carried out in the setting block, carrying out direct play with respect to the information recording medium mounted in the mounting block on the basis of information indicating a title for carrying out direct play included in the management information contained in the information recording medium mounted in the mounting block.

9. An information recording medium having recorded therein information corresponding to a title and management information that includes information for displaying a menu screen for playing the title, the medium being mounted on an information playing apparatus to carry out playing of recorded information, wherein
the management information includes information for enabling or disabling the information playing apparatus to carry out direct play of information corresponding to a preset title from the information recording medium without playing the information for displaying the menu screen.

10. An information recording medium according to claim 9, wherein the management information includes information indicating a title for the information playing apparatus to carry out direct play.
